(19) United States
(12) Patent Application Publication
(10) Pub. No.: US 2010/0329458 A1
(43) Pub. Date: Dec. 30, 2010

(54) SMARTCARD, HOLDER AND METHOD FOR LOADING AND UPDATING ACCESS CONTROL DEVICE FIRMWARE AND/OR PROGRAMS

(76) Inventor: Anshuman SINHA, Boca Raton, FL (US)

Correspondence Address: General Electric Company;GE Global Patent Operation, 2 Corporate Drive, Suite 648, Shelton, CT, 06484, US

(21) Appl. No.: 12/494,985

(22) Filed: Jun. 30, 2009

(51) Int. Cl. G06K 19/06; G06K 7/00; G06K 5/00; H05K 7/10; H04L 9/00; G06F 9/445

(52) U.S. Cl. 380/255; 235/492; 235/486; 235/380; 710/301; 717/174

(57) ABSTRACT

A smartcard having a secure memory storing new firmware, new programs, and/or updated firmware and/or programs. A holder configured to receive the smartcard and to position the smartcard within communication range of an access control device. Methods for loading and/or updating access control device firmware, programs and/or software.

### CROSS-REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### REFERENCE TO A SEQUENCE LISTING, A TABLE, OR COMPUTER PROGRAM LISTING APPENDIX SUBMITTED ON COMPACT DISC

Not Applicable

### BACKGROUND OF THE INVENTION

1. Field of the Invention

The field of the invention relates to access control systems generally, and more particularly to certain new and useful advances in smartcards of which the following is a specification, reference being had to the drawings accompanying and forming a part of the same.

2. Description of Related Art

FIGS. 1, 2, 3 and 4 illustrate conventional methods for loading programs and/or firmware to a smartcard card reader.

In FIG. 1, a conventional system 100 has several components: a computer 101 that is coupled via a cable 109 to an integrated circuit emulator (“ICE”)/Dedicated Hardware 103 and a smartcard reader 102. As indicated by arrow 104, new firmware, new programs, and/or firmware and/or program updates are pushed from the computer 101 to the smartcard reader 102. The computer 101 has a port 105 that is coupled with the ICE/Dedicated Hardware 103. The port 105 is a USB, RS 232, or other suitable port. The smartcard reader 102 uses a port 106 to couple with the ICE/Dedicated Hardware 103. The port 106 is a custom port or a standard connector.

FIG. 2 is an alternate setup of the system 100 in which the computer 101 is directly connected to the smartcard reader 102 via the cable 109. One end of the cable 109 couples with the port 105 of the computer 101. The cable's other end couples with the port 106 of the smartcard reader 102. As indicated by arrow 104, the computer 101 pushes new firmware, new programs, and/or firmware and/or program updates over the cable 109 to the smartcard reader 102.

As shown in FIG. 3, with reference back to FIGS. 1 and 2, a method 200 includes connecting 201 an ICE/Dedicated Hardware 103 to the smartcard reader 102. The method 200 further includes connecting 202 the ICE/Dedicated Hardware 103 to the computer 101. The method 200 further includes starting 203 a program and/or the computer 101 to couple the hardware and processor to the smartcard reader 102. The method 200 further includes initiating 204 loading the new firmware, new software, new programs and/or firmware, software and/or program updates from the computer 101. At decision block 205, it is determined whether an error has occurred in the loading. If yes, the method 200 loops back and repeats steps 204 and 205. Otherwise, the method 200 ends.

As shown in FIG. 4, with reference back to FIG. 1, the computer 101 includes a processor 120, a communication interface 110 for ICE/Dedicated Hardware 103, and a memory 126. The memory 126 stores a file 128 containing new firmware, new programs, and/or updated firmware and/or programs. Also included in the memory 126 is a loader 130, which is a computer program that communicates with the smartcard reader 102. It also performs any security check required before allowing the loading step 204 to commence. In some conventional systems 100, however, there is no security check.

In summary, referring to FIGS. 1 and 2, updating a smartcard reader 102 with firmware and/or programs has been difficult and cumbersome, because a single programmer uses the computer 101, which may be a single board or a laptop, with its own supporting infrastructure 103, 109, and the extra hardware and/or software requirements of the computer 101 and/or the supporting infrastructure 103, 109 often complicates the issue of reloading and/or updating the firmware and/or programs. Moreover, security of the access control system could be compromised by a person that obtains access to the computer 101 for they then could easily retrieve the smartcard reader firmware and/or programs and can load them on different hardware. Additionally, the computer 101 needed to program the firmware has its own costs, which are often more than the cost of a smartcard.

What is needed is a secure and easy-to-use system and method for loading and/or updating access control firmware and/or programs.

### BRIEF SUMMARY OF THE INVENTION

A secure and easy-to-use, system and method for providing new firmware, new programs, and/or updated firmware and/or programs to one or more deployed smartcard readers in an access control system. In one embodiment, a smartcard is configured to perform firmware and/or program initialization, load and/or update for a contactless access control device via Radio Frequency Identification (“RFID”), near field or other form of wireless communication. Alternatively, the smartcard is configured to perform firmware and/or program initialization, load and/or update for a contact access control device.

An advantage over the conventional systems and methods described above is that an embodiment of the system and method described herein provides secure programming and/or reprogramming an access control device by restricting the programming and/or reprogramming to at least one person having predetermined credentials and using a smartcard that has a secure and tamper-proof memory that contains access control device firmware, software and/or programs. The access control device firmware, software and/or programs may be new (meaning never before installed on an access control device) or updated (meaning a different version than previously installed on an access control device). Another advantage is that the programming and/or reprogramming of the access control device(s) can be performed without additional hardware. Another advantage is that the programming and/or reprogramming of the access control device can be performed incrementally by a user of the smartcard, so that the person would not need to hold the smartcard in a continuous single long session to load the firmware and/or programs. Thus, the loading and/or updating are done in a single transaction, which can last multiple sessions.

Loading the access control device firmware, software and/or programs first into a smartcard, which is a secure, tamperproof device, solves the problem of security described above because the access control device cannot retrieve the access control device firmware, software and/or programs without authentication. Authentication involves checking that the smartcard is valid and thereafter opening a secure communication channel between the smartcard and the smartcard reader.

A holder configured to position a smartcard relative to an access control device is also disclosed.

Other features and advantages of the disclosure will become apparent by reference to the following description taken in connection with the accompanying drawings.

### BRIEF DESCRIPTION OF THE DRAWINGS

Reference is now made briefly to the accompanying drawings, in which:

FIG. 1 and FIG. 2 are diagrams of conventional systems;

FIG. 3 is a conventional method of loading and/or updating firmware and/or programs to a known smartcard reader;

FIG. 4 is a block diagram of components of a conventional computer that is configured to be used in the conventional access control systems of FIGS. 1 and 2;

FIG. 5A is a block diagram of components of an access control device configured according to an embodiment of the invention;

FIG. 5B is a block diagram of components of a smartcard reader configured according to an embodiment of the invention;

FIG. 6 is a block diagram of an embodiment of an improved system;

FIG. 7 is a diagram of an embodiment a holder configured to be used with an access control device;

FIG. 8 is a top view of the holder of FIG. 7;

FIG. 9 is a bottom view of the holder of FIG. 7;

FIG. 10 is a side view of the holder of FIG. 7 with a smartcard inserted therein;

FIG. 11 is a side view of an improved access control device configured to couple with the holder of FIGS. 7, 8, 9, and 10;

FIG. 12 is a flow chart that depicts an embodiment of an improved method of loading and/or installing access control device firmware, software and/or programs to an access control device; and

FIG. 13 is a block diagram of an embodiment of a smartcard.

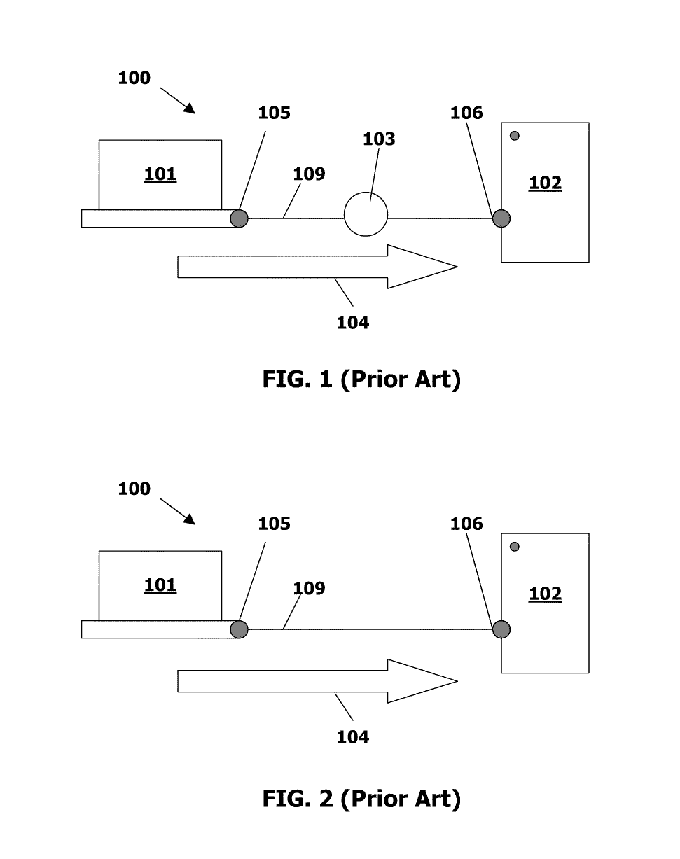

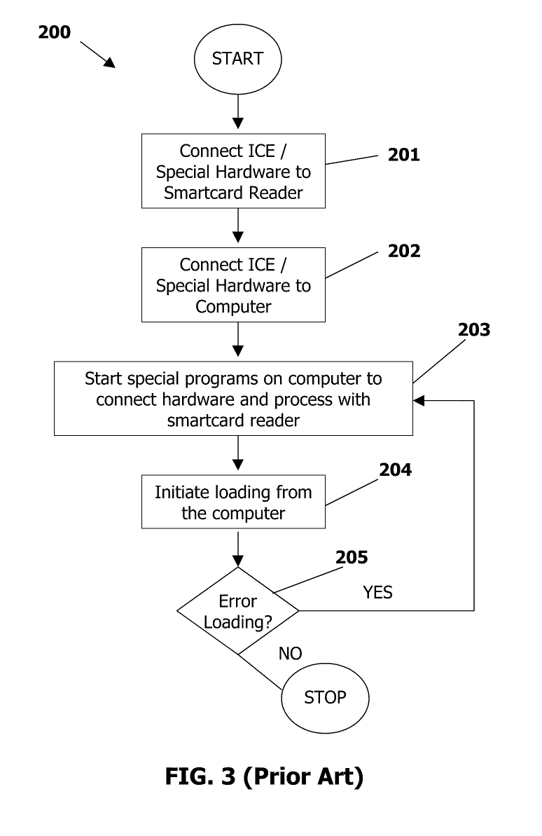

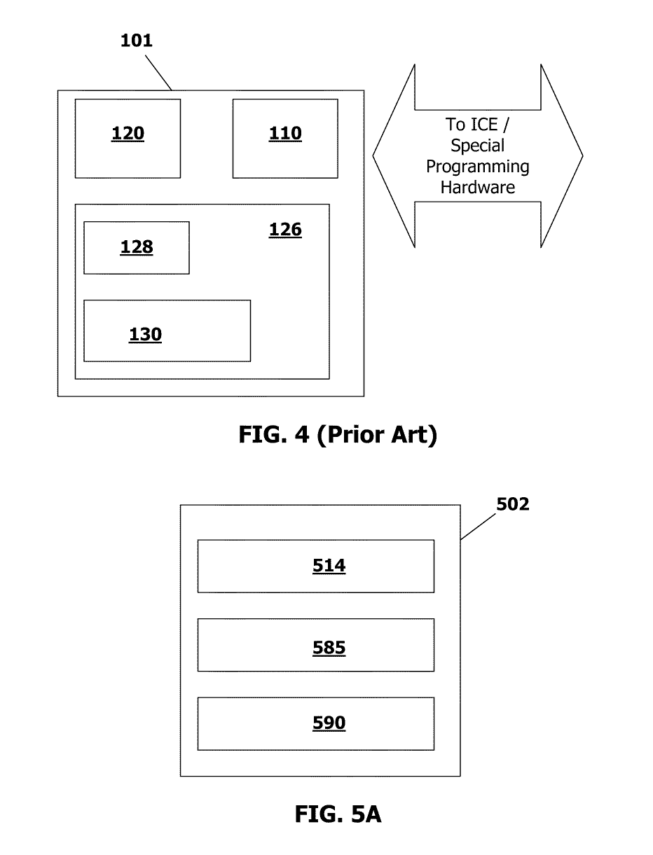

Like reference characters designate identical or corresponding components and units throughout the several views, which are not to scale unless otherwise indicated.

### DETAILED DESCRIPTION OF THE INVENTION

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

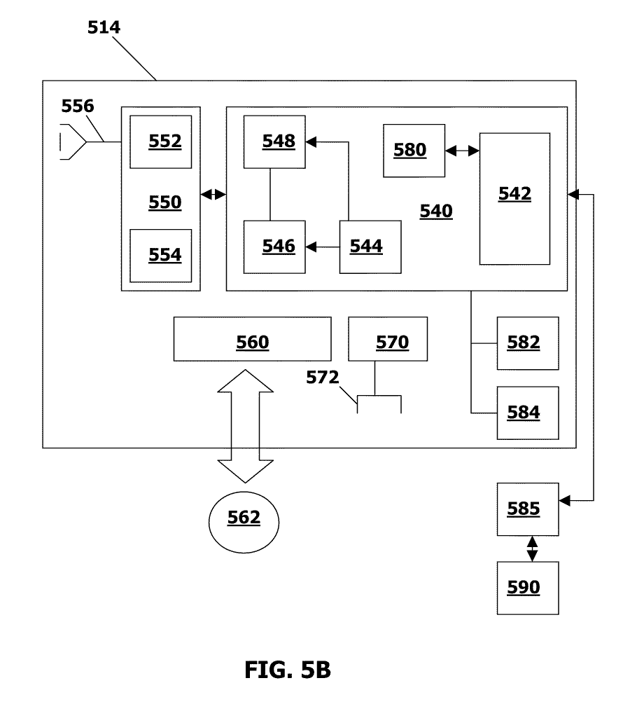

As shown in FIG. 5A, an improved access control device 502 may comprise one or more of the following: a smartcard reader 514, a bridge 585, and a controller 590. A bridge 585 is a device that couples between a controller 590 and the smartcard reader 514, and is configured to translate data signals that flow between the smartcard reader 514 and the controller 590.

As shown in FIG. 5B, an embodiment of a smartcard reader 514 comprises several components. For example, the smartcard reader 514 comprises a transceiver 550 coupled with an antenna 556. The antenna 556 is configured to establish a communication channel with a smartcard. Depending on the embodiment, the antenna 556 may be configured to energize a smartcard that is placed within communication range and power range of the antenna 556. The smartcard reader 514 may further comprise one or more status indicators 582 and/or a display 584, each of which may be coupled with the processor 540. Although only one processor 540 is depicted for ease of illustration, the smartcard reader 514 may comprise a plurality of processors 540.

The transceiver 550 comprises a transmitter 552 and a receiver 554. The transceiver 550 is configured to communicate with the processor 540. The processor 540 comprises a memory 542, an encoder 548, a decoder 546, a logic 544, and a loader 580, which is coupled with the memory 542. The loader 580 is configured to load the firmware from the memory 542 and to self-configure one or more components of the smartcard reader 514 to reset and/or install access control device firmware, software and/or programs received from a memory of a smartcard. Additionally, the smartcard reader 514 has a communication interface logic 560 that communicates with the processor 540. The smartcard reader 514 also has a power source 570 that is coupled with the processor 540. The communication interface logic 560 can be coupled with a network 562. The power source 570 is connected to supply rails 572. The smartcard reader 514 is configured to detect a smartcard and/or to read the smartcard.

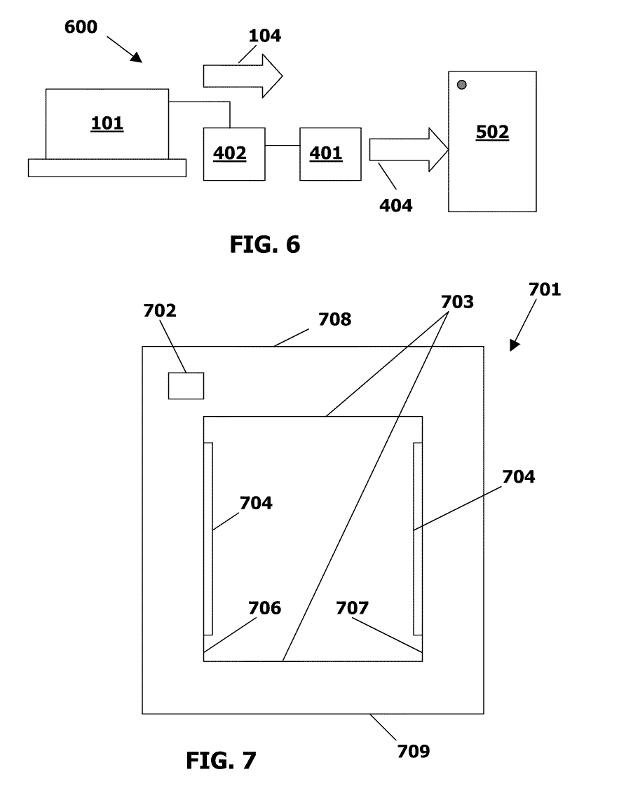

Referring to FIG. 6, an improved system 600 comprises at least a smartcard 401 and a desktop smartcard encoder 402. The system 600 may also comprise a computer 101 coupled with the desktop smartcard encoder 402. The system 600 may also further comprise one or more access control devices 502. As indicated by the arrow 104, access control device firmware, software and/or programs are pushed from the computer 101 to, and stored in a memory of, the desktop smartcard encoder 402. When the smartcard 401 is positioned within communication range of the desktop smartcard encoder 402, the desktop smartcard encoder 402 writes the stored access control device firmware, software and/or programs to a secure memory of the smartcard 401. Thereafter, when the smartcard 401 is brought within communication range of one or more deployed access control devices 502, the access control device firmware, software and/or programs stored in the smartcard's secure memory is/are transmitted to the access control device 502, as indicated by arrow 404.

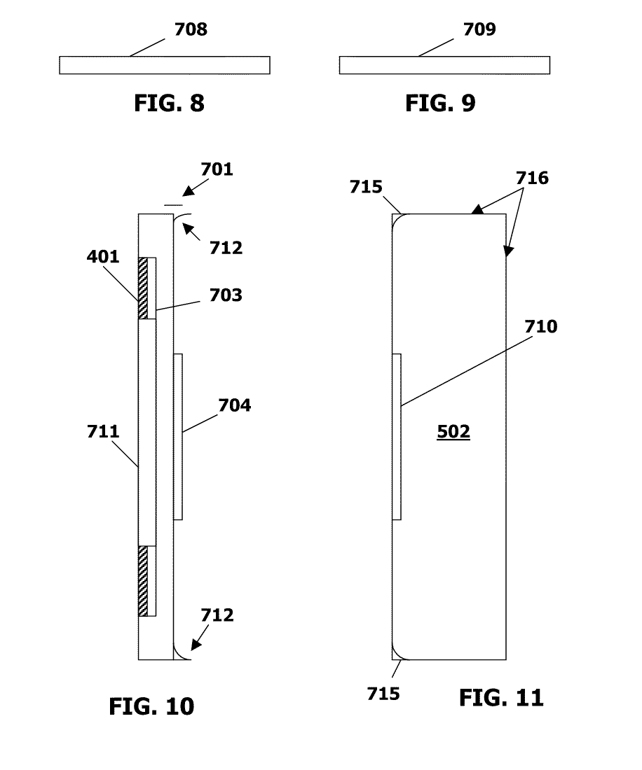

Referring to FIG. 7, a holder 701 that is configured to position the smartcard 401 relative to an access control device (502 in FIG. 11). FIG. 8 is a view of a top surface 708 of the smartcard holder 701 of FIG. 7. FIG. 9 is a view of a bottom surface 709 of the smartcard holder 701 of FIG. 7. FIG. 10 is a side view of the holder 701 of FIG. 7 with a smartcard 401 inserted therein. FIG. 11 is a side view of an improved access control device 502 configured to couple with the smartcard holder of FIGS. 7, 8, 9, and 10.

The dimensions of holder 701 will vary depending on the type of access control device 502 it is configured to service, but generally speaking, the holder 701 is configured to couple with one or more surfaces of the access control device 502. More particularly, the holder 701 is configured to position the smartcard 401 within a communication range of the access control device 502 for a predetermined period of time so that an operator of the smartcard 401 does not need to hold the smartcard 401 proximate the access control device 502 while the smartcard reader's firmware and/or software are updated. The holder 701 is further configured to be decoupled from the access control device 502 once the firmware, program and/or software updates have been completed.

Referring to FIGS. 7, 8, 9, 10, and 11, the holder 701 is a rigid, or semi-rigid substrate formed of any suitable material or combination of materials. By way of example, and not limitation, the holder 701 can be formed of any injection-moldable material in combination with known injection molding techniques. One or more fasteners 704, 711 of the holder 701 may be snap fits of the type called “multiple snaps”—meaning that these one or more components of the holder 701 are configured to be coupled and decoupled with objects such as a smartcard 401 and an access control device (502 in FIG. 11) multiple times.

As shown in FIG. 7, the holder 701 has an aperture 702 formed therein, which extends completely through the substrate. The aperture 702 is illustratively shown positioned between an outer edge 704 of the holder 701 and an edge of the receptor 703, but its exact position will vary depending on the position of a smartcard reader's status indicators and/or display. Thus, the aperture 702 is configured to permit viewing of a portion of an access control device (502 in FIG. 11). The portion of the access control device 502 viewable through the aperture 702 when the holder 701 is proximate and/or coupled with the access control device 502 may comprise one or more status indicators 582 (FIG. 5B) and/or a display 584 (FIG. 5B).

Referring to FIGS. 7 and 11, the first fastener 704 is coupled or integrally formed with the holder 701. The first fastener 704 may be positioned on a surface of the smartcard holder 701 that will be adjacent to a front surface of the access control device 502. The first fastener 704, or a component thereof, may be formed along each of edges 706 and 707 of the receptor 703. The first fastener 704 is configured to couple with a corresponding second fastener 710 (FIG. 11) that is coupled or formed integrally with a cover, or a surface, of the access control device 502. In one embodiment, the first fastener 704 associated with the holder 701 is a clip or tab, and the second fastener 710 associated with the access control device 502 is a recess, such as a slot or a groove.

Referring to FIGS. 7 and 10, the holder 701 also has a receptor 703 formed therein. The receptor 703 is a recessed area of the holder 701 that is configured to receive the smartcard 401. One or more third fasteners 711 are formed at a periphery of the receptor 703 and configured to retain, or snap-fit, the smartcard 401 within the receptor 703. The receptor 703 is illustratively shown centered in the holder 701, but its exact position and/or dimensions will vary depending on the configuration(s) of the smartcard 401 and/or the access control device 502 in FIG. 11.

Additionally, referring to FIGS. 10 and 11, the holder 701 may comprise one or more portions 712 that are configured to couple with corresponding portions 715 of the access control device 502. In one embodiment, the portions 712 of the holder 701 are concave, and the corresponding portions 715 of the access control device 502 are convex, but other configurations are possible and contemplated. In one embodiment, the portions 715 of the access control device 502 are part of, or coupled with, a housing 716 of the access control device 502. The above is merely exemplary, it being understood that the portions 712, 715 can have any suitable shape and/or cross-section.

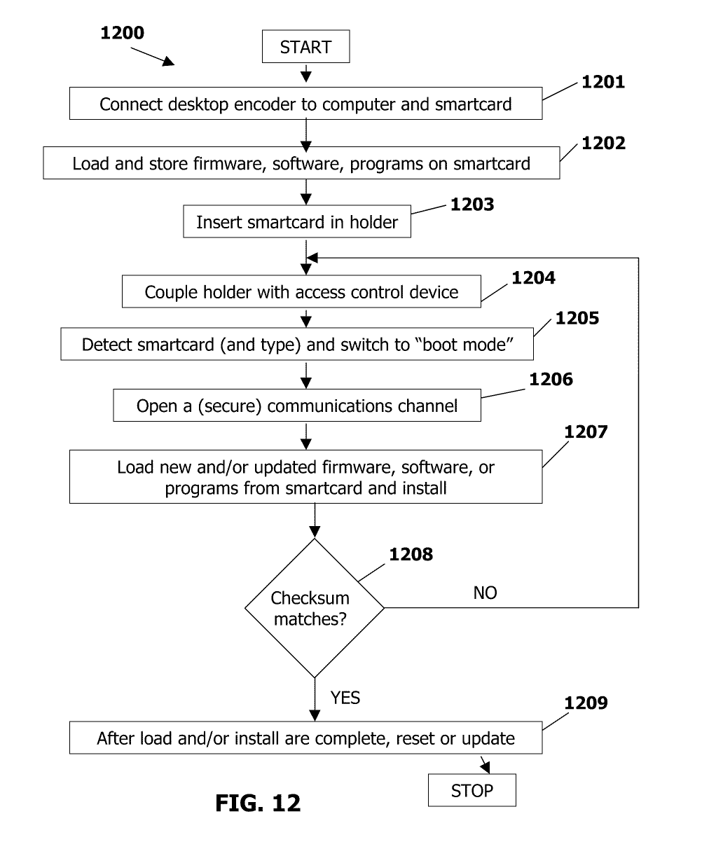

Referring to FIG. 12, together with FIGS. 6 and 7, an embodiment of a method 1200 comprises one or more steps 1201, 1202, 1203, 1204, 1205, 1206, 1207, 1208 and/or 1209. For example, the method 1200 may comprise coupling 1201 a smartcard 401 with a smartcard encoder 402 that is connected to a computer 101. The method 600 may further comprise loading 1202 stored access control device firmware, software and/or programs from the smartcard encoder 402 to the smartcard 401. The method 1200 may further comprise coupling 2103 the smartcard 401 directly with one or more access control devices 502, or alternatively with the holder 701. The coupling 1203 with the holder 701 may comprise placing the smartcard 401 in the receptor 703 of the holder 701. Optionally, the method 600 may further comprise attaching, or positioning, 1204 the holder 701 on, and/or proximate, the access control device 502 so the smartcard 401 is placed within communication range and power range of an antenna of the access control device 502. In one embodiment, the smartcard 401 and the antenna of the access control device 502 are aligned. The method 1200 may further comprise detecting 1205 the smartcard 401. Once the smartcard 401 is detected, a processor of the access control device 502 may automatically switch to “boot” mode in response to instructions received from a loader 580 (FIG. 5B) of the access control device 502. The method 1200 may further comprise opening 1206 a secure communications channel between the smartcard 401 and the access control device 502. The method 1200 may further comprise loading 1207 the access control device firmware, software and/or programs from the smartcard 401 to the access control device 502 using a loader of the access control device 502. The loading step 1207 may also comprise verifying a checksum to ensure the loaded access control device firmware, software and/or programs are complete and/or free of errors. At decision block 1208, the method 1200 comprises determining whether the checksum verified in step 1207 matches. If not, the method 1200 loops back to and repeats step 1204, 1205, 1206, and 1207. If the checksum matches, the method 1200 may further comprise resetting or updating 1209 the access control device 502. Thereafter, the method 1200 may end.

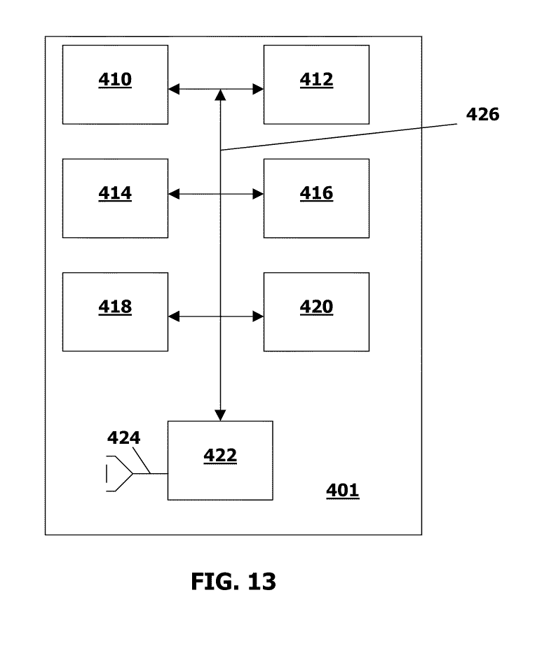

Referring to FIG. 13, a block diagram of an embodiment of a smartcard 401 is shown. The smartcard 401 may comprise a bus 426, to which are coupled one or more of the following: a volatile memory 410, a non-volatile memory 412, a cryptographic processor 414, a processor 416, a power source 418, a clock 420, and a contactor or contactless input/output interface 422 that may be coupled with an antenna 424. The access control device firmware, software and/or programs are stored in the at least one of the volatile memory 410 and the non-volatile memory 412.

Select ones of the components 410, 412, 414, 416, 418, 420, 422 and 424 illustratively shown in FIG. 13 may be omitted, depending on the embodiment. For example, some smartcards 401 will have the cryptographic co-processor 414, in addition to the processor 416, while other smartcards 401 will not.

Moreover, in one embodiment, the smartcard 401 is a contact card configured to be used with a contact access control device 502. In another embodiment, the smartcard 401 is a contactless card configured to be used with a contactless access control device 502.

Referring back to FIG. 5A, in another embodiment, a smartcard 401 is configured to transfer access control device firmware, software and/or programs to a bridge 585 using a smartcard reader 514 as an intermediary. In such an embodiment, the smartcard reader 514 is configured to pass the access control device firmware, software and/or programs to the bridge 585. Upon receiving the access control device firmware, software and/or programs, the bridge 585 self-configures the installation of the access control device firmware, software and/or programs into a memory of the bridge 585.

In one embodiment, a smartcard reader 514 is configured to distinguish between an identity smartcard and an update smartcard. The identity smartcard is a smartcard containing identity information of a user of the smartcard, but not containing any access control device firmware, software and/or programs. The update smartcard is a smartcard having a memory that contains access control device firmware, software and/or programs for transmission to an access control device.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the scope of the following claims.

What is claimed is:

1. A smartcard, comprising:
a memory configured to store access control device firmware, software and/or programs for subsequent transmission to the access control device.

2. The smartcard of claim 1, wherein the access control device is a smartcard reader.

3. The smartcard of claim 1, wherein the access control device is one of a controller and a bridge that is configured to couple the controller with a smartcard reader.

4. A smartcard reader, comprising:
a memory containing firmware; and
a loader coupled with the memory and configured to load the firmware and to self-configure one or more components of the smartcard reader to reset and/or install access control device firmware, software and/or programs previously stored in a memory of a smartcard.

5. The smartcard reader of claim 4, wherein the smartcard reader is configured to detect the smartcard.

6. The smartcard reader of claim 4, wherein the smartcard reader is configured to read the smartcard.

7. The smartcard reader of claim 4, wherein the smartcard reader is configured to distinguish between an identity smartcard and an update smartcard, wherein the identity smartcard is a smartcard containing identity information of a user of the smartcard, and wherein the update smartcard is a smartcard having the memory that stores the access control device firmware, software and/or programs.

8. The smartcard reader of claim 4, wherein a portion of the smartcard reader is configured to couple with a holder, and wherein the holder is configured to couple with the smartcard.

9. The smartcard reader of claim 8, wherein the holder comprises:
a substrate having a portion configured to couple with the portion of the smartcard reader;
an aperture formed through the substrate and configured to permit viewing of a portion of the smartcard reader when the substrate is proximate the smartcard reader; and
a receptor coupled with the substrate and configured to receive the smartcard.

10. A system, comprising:
a smartcard encoder;
a smartcard having a memory configured to store access control device firmware, software and/or programs loaded from the smartcard encoder; and
a smartcard reader having a memory containing firmware and having a loader coupled with the memory of the smartcard reader and configured to self-configure an installation of the access control device firmware, software and/or programs received from the memory of the smartcard.

11. A method, comprising:
coupling a smartcard with a smartcard encoder that is coupled with a computer; and
loading stored access control device firmware, software and/or programs from the smartcard encoder to the smartcard.

12. The method of claim 11, further comprising:
coupling the smartcard with a deployed smartcard reader;
establishing a communications channel between the smartcard and the smartcard reader; and
transmitting the access control device firmware, software and/or programs from the smartcard to the smartcard reader.

13. The method of claim 11, wherein the communications channel is encrypted.

14. The method of claim 11, further comprising:
coupling the smartcard with a holder.

15. The method of claim 14, wherein the holder is configured to receive the smartcard and also configured to couple with a portion of an access control device.

16. The method of claim 14, further comprising:
positioning the holder proximate an access control device so the smartcard is placed within communication range and power range of an antenna of the access control device.

17. The method of claim 16, further comprising:
opening a communications channel between the smartcard and the access control device; and
transmitting the access control device firmware, software and/or programs from the smartcard to the access control device.

18. The method of claim 14, wherein the coupling of the smartcard with the holder comprises placing the smartcard in a receptor of the holder.

19. A holder, comprising:
a substrate having a portion configured to couple with a portion of an access control device;
an aperture formed through the substrate and configured to permit viewing of a portion of the access control device when the substrate is proximate the access control device; and
a receptor coupled with the substrate and configured to receive a smartcard.

20. The holder of claim 19, wherein the access control device is a smartcard reader.
